(19) United States
(12) Patent Application Publication
(10) Pub. No.: US 2020/0141425 A1
(43) Pub. Date: May 7, 2020

(54) HYDRAULIC PUMP VALVE APPARATUS FOR A PRESSING TOOL

(71) Applicant: Von ARX AG, Sissach (CH)

(72) Inventors: Matthias RUCH, Efringen-Kirchen (DE); Rudolf KREUZER, Buchs (CH)

(21) Appl. No.: 16/666,702

(22) Filed: Oct. 29, 2019

(30) Foreign Application Priority Data
Nov. 6, 2018 (EP) EP 18204528.6

(51) Int. Cl. F15B 9/08; B21D 39/04; F04B 9/103

(52) U.S. Cl. CPC F15B 9/08; F16K 17/0406; F04B 9/103; B21D 39/048

(57) ABSTRACT

A pressing tool for plastically deforming a tubular workpiece. The pressing tool comprises a drive, a reservoir for providing a hydraulic fluid, a coupling interface for coupling the pressing tool to a pressing jaw assembly, and a hydraulic pump valve apparatus. The hydraulic pump valve apparatus comprises a pressure cylinder, an operating cylinder, and a pressure-relief valve element which is adapted to open a fluidic passage from the operating cylinder to the reservoir when a predefined maximum pressing pressure is reached and keep it open until the operating piston has returned to a first position.

### FIELD

The present invention relates to a pressing tool, particularly a hand-held pressing tool for pressing tubular workpieces, and to a method of operating a pressing tool.

### BACKGROUND

Several methods of joining tubular workpieces are known in the prior art. For example, pipes may be soldered or welded together. Furthermore, putting the end of a smaller pipe into one end of a larger pipe and subsequently pressing the two pipes against each other is known.

In other cases, compressing is carried out using a (compression) fitting. For this purpose, pressing tools such as pipe pressing tools may be used in order to join a pipe to a compression fitting. Such a fitting may be designed as a piping and plumbing fitting that may be used as an adapter in a pipe, for example. The ends of the pipes to be joined together are inserted into the fitting, and the fitting is subsequently pressed against the ends of the pipes. A fitting may be made from various materials such as copper, aluminum, plastics, composite material and/or (stainless) steel.

Typically, the pressing is performed by means of a hand-held and motor-powered pressing tool. Typically, electrical and/or hydraulic drives are used. The pressing tool may comprise interchangeable tools such as pressing jaws of different sizes and geometries, for example. A (tube) pressing tool may comprise pressing jaws made from copper or steel, for example. Furthermore, the pressing tool may comprise an interchangeable tool head such as pressing pliers which comprises the pressing jaws. Apart from this, pressing tools are also known for other tasks; for example, pressing tools are used to press, crimp or cut workpieces in the electronics industry, for example. In particular, a task-specific tool head and/or task-specific pressing jaws may be arranged at the pressing tool in order to process workpieces accordingly.

In the case of a hand-held pressing tool, the pressing jaws are arranged around the compression fitting for pressing. When the pressing jaws are closed, a force is applied to the surface of the compression fitting, so that the fitting is compressed and plastically deforms in the process, whereby the workpieces are safely joined together. In the course of this, the inner tubes may also be plastically deformed. Equally, for the purpose of cutting and/or crimping, corresponding pressing jaws are arranged around the workpiece, and when the pressing jaws are closed, a force is applied to the workpiece in order to cut or crimp the workpiece.

In pressing tools of the prior art, the pressing process is usually ended by a pressure-relief valve being opened when a certain maximum pressure is reached. The defined maximum pressure ensures that a suitably high pressing force was applied to the workpiece in order to guarantee sufficient compression. For the purpose of generating the required high pressing forces, pressing tools are typically connected to an electro-hydraulic converter. The converter comprises an operating cylinder which drives the pressing jaws. The operating cylinder is hydraulically connected to a pressure cylinder which is driven by means of a drive. The drive typically comprises an electric motor. When the pressure cylinder is driven, the hydraulic oil is pressed into the operating cylinder. As soon as the required pressing force is reached, a pressure-relief valve opens and the hydraulic oil may flow back into a non-pressurized reservoir and the operating cylinder may be returned. Opening the pressure-relief valve leads to a dramatic drop of the motor current. This is recognized by a control of the pressing tool, and the electric motor is subsequently switched off.

In known pressing tools, opening the pressure-relief valve leads to the opening of another valve (referred to as switching valve hereinafter), so that the hydraulic oil may flow back into the non-pressurized reservoir from the pressure cylinder. Hence, the pressure cylinder may also be returned. After the return of the operating and pressure cylinder, the switching valve is closed, i.e. the hydraulic oil may now only flow to the operating cylinder from the pressure cylinder, and the pressing tool is ready for a new pressing cycle.

Thus, a known pressing tool comprises an electro-hydraulic converter which comprises at least an operating cylinder (with a piston), a pressure cylinder (with a piston), a drive as well as a pressure-relief valve and a switching valve. The provision of the pressure-relief valve and the controllable switching valve in particular results in a complex structure and a large size of pressing tools known in the art.

Therefore, the problem of the present invention is to provide a pressing tool which is smaller and less complex. Pressing tools that are smaller may be used in a more variable manner. In particular, small pressing tools may make the joining of tubes in confined installation spaces by means of pressing possible.

### SUMMARY

The difficulties and drawbacks associated with previous approaches are addressed in the present subject matter as follows.

In one aspect, the present subject matter provides a pressing tool for plastically deforming a tubular workpiece. The pressing tool comprises a drive and a reservoir for providing a hydraulic fluid. The pressing tool also comprises a coupling interface for coupling the pressing tool to a pressing jaw assembly. The pressing tool also comprises a hydraulic pump valve apparatus. The hydraulic pump valve apparatus comprises a pressure cylinder in which a pressure piston is mounted in a movable manner. The pressure piston may be driven by means of the drive. The hydraulic pump valve apparatus also comprises an operating cylinder in which an operating piston is mounted in a movable manner in order to be moved from a first position into a second position. The operating cylinder is fluidically connected to the pressure cylinder, so that hydraulic fluid may be driven to the operating cylinder from the pressure cylinder by means of the pressure piston in order to apply a pressing pressure to the operating piston and move it into the second position. The operating piston is coupled to the coupling interface and the coupling interface is adapted to transmit a pressing force from the operating piston to a pressing jaw assembly when the pressing jaw assembly is coupled to the coupling interface. The hydraulic pump valve apparatus also comprises a pressure-relief valve element which is adapted to open a first fluidic passage from the operating cylinder to the reservoir when a predefined maximum pressing pressure is reached, and wherein the pressure-relief valve element is further adapted to keep open the first fluidic passage until the operating piston has returned into the first position.

In another aspect, the present subject matter provides a method of operating a pressing tool. The method comprises providing a pressing tool including a drive, a reservoir for providing a hydraulic fluid, a coupling interface for coupling the pressing tool to a pressing jaw assembly, and a hydraulic pump valve apparatus. The hydraulic pump valve apparatus includes (i) a pressure cylinder in which a pressure piston is mounted in a movable manner, wherein the pressure piston may be driven by means of the drive, (ii) an operating cylinder in which an operating piston is mounted in a movable manner in order to be moved from a first position into a second position, and (iii) a pressure-relief valve element which is adapted to open a first fluidic passage from the operating cylinder to the reservoir when a predefined maximum pressing pressure is reached. The method also comprises providing a pressing jaw assembly comprising at least one pressing jaw. The method further comprises coupling the pressing jaw assembly to the coupling interface of the pressing tool. The method also comprises gripping the workpiece by means of the at least one pressing jaw. The method additionally comprises driving the pressure piston by means of the drive in order to drive hydraulic fluid to the operating cylinder from the pressure cylinder by means of the pressure piston. The method further comprises applying pressing pressure to the operating piston in order to move the operating piston into a second position. The method also comprises transmitting pressing force from the operating piston to the pressing jaw assembly in order to plastically deform the gripped workpiece. The method further comprises opening the first fluidic passage by means of the pressure-relief valve element when a predefined maximum pressing pressure is reached. And, the method comprises keeping open the first fluidic passage until the operating piston has returned into the first position.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 shows a schematic illustration of an embodiment of a pressing tool.

FIG. 2 shows a schematic illustration of an embodiment of the pressing tool as a hydraulic hand-held pressing device according to the present invention.

FIG. 3 shows a further schematic illustration of an embodiment of a pressing tool.

### DETAILED DESCRIPTION OF THE EMBODIMENTS

In particular, the problem is solved by a pressing tool which comprises a drive, a reservoir for providing a hydraulic fluid, a coupling interface for coupling the pressing tool and a pressing jaw assembly together, and a hydraulic pump valve apparatus. The pressing tool may be a pipe pressing tool, in particular, and be adapted to safely press pipes and/or fittings together. Equally, the pressing tool may be a cutting tool, a crimping tool or a similar tool.

The coupling interface may couple to the pressing jaw assembly in such a manner that the pressing tool may drive pressing jaws of the pressing jaw assembly. In this context, the coupling interface may be configured in such a way that the pressing jaw assembly may be exchanged in order to be able to couple different pressing jaw assemblies to the pressing tool. Likewise, the coupling interface may be adapted for the fixed reception of a pressing jaw assembly, so that exchanging the pressing jaw assembly is not easily possible. For example, a pressing tool may comprise a coupling interface for compressing fittings, which interface makes it possible for the pressing jaw assembly to be exchanged. Equally, a pressing tool may comprise a coupling interface for the fixed reception of a pressing jaw assembly, particularly for use in the field of electrical engineering, for example for cutting wire.

For example, the coupling takes place by at least one coupling bolt and/or a coupling roller. Furthermore, the pressing jaw assembly comprises pressing jaws, wherein at least one pressing jaw may be interchangeable. At least one of the pressing jaws of the pressing jaw assembly is arranged in a movable manner. Thus, the pressing jaws may be closed and opened, i.e. spread apart. In the spread state, for example a tubular workpiece such as a fitting may be arranged between the pressing jaws. When the pressing jaws are closed, the workpiece is plastically deformed. In particular, different pressing jaw assemblies and/or pressing jaws may be designed for different tasks such as pressing, crimping, or cutting, and may differ from each other in terms of the shape and material. For example, the pressing jaws/pressing jaw assemblies used in the pressing of copper fittings differ from those used in the pressing of (stainless) steel fittings. The pressing tool may be adapted for different workpieces, particularly fittings, by exchanging the pressing jaws/pressing jaw assemblies. Equally, the pressing jaws/pressing jaw assembly may match the geometry of the workpiece to be processed.

The hydraulic pump valve apparatus of the pressing tool comprises a pressure cylinder in which a pressure piston is mounted in a movable manner, wherein the pressure piston may be driven by means of the drive. In particular, the drive may be a rotating drive and comprise a transmission element which transforms the rotary motion of the drive into a linear motion. Furthermore, the hydraulic pump valve apparatus comprises an operating cylinder in which an operating piston is mounted in a movable manner in order to be moved from a first position into a second position. The operating cylinder is fluidically connected to the pressure cylinder, so that hydraulic fluid may be driven to the operating cylinder from the pressure cylinder by means of the pressure piston. Hence, a pressing pressure may be applied to the operating piston, and the operating piston may be moved into the second position as a consequence of the pressure.

The cylinders and/or pistons of the hydraulic pump valve apparatus may be selected in such a manner that a desired mechanical advantage is achieved. Potential hydraulic fluids are hydraulic oils according to ISO 6743/4 according to DIN 51 524. Different hydraulic fluids may also be used.

In the first position, the pressing jaws are typically spread apart, and the operating piston is at least partially retracted. Once the piston is moved out of the first position in the direction of the second position, the spread pressing jaws start closing. When the second position is reached, the pressing jaws are typically closed. The operating piston is at least partially extended, and a predefined maximum pressing pressure was reached in the operating cylinder. Thus, when the operating piston is moved into the second position from the first position, a workpiece is plastically deformed if a pressing jaw assembly is coupled to the pressing tool and a suitable workpiece has been received in the pressing jaw assembly. For this purpose, the operating piston is coupled to the coupling interface, and the coupling interface is adapted to transmit a pressing force from the operating piston to the pressing jaw assembly if the pressing jaw assembly is coupled to the coupling interface. By means of the operating piston, the pressing pressure that exists in the operating cylinder is turned into a pressing force which is transmitted to the pressing jaw assembly and/or the pressing jaws.

Additionally, the hydraulic pump valve apparatus of the pressing tool comprises a pressure-relief valve which is adapted to open a first fluidic passage from the operating cylinder to the reservoir when a predefined maximum pressing pressure is reached and to keep the first fluidic passage open until the operating piston has returned to the first position. Thus, the pressing tool is ready for a new pressing process, i.e. the operating piston may be moved out of the first position in the direction of the second position again after the first fluidic passage has been closed.

Opening and keeping open the first fluidic passage makes omitting the switching valve, which was necessary in the pressing tools of prior art, possible. Hence, building a smaller and lighter pressing tool becomes possible. Additionally the assembly effort and complexity of the hydraulic system are reduced.

In particular, the hydraulic pump valve apparatus may be integrated in a housing component and aggregate into an integrated component the functions of applying the pressing pressure to the operating piston, stopping the application of pressure by opening the first fluidic passage, and the return flow of the hydraulic fluid into the reservoir from the operating piston. Thus, the complexity of the hydraulic system and the assembly of the pressing tool are simplified.

Additionally, the hydraulic pump valve apparatus may comprise a first valve element which is arranged between the reservoir and the pressure cylinder and is adapted to prevent a return flow of hydraulic fluid into the reservoir from the pressure cylinder. Hence, it may be ensured that the hydraulic fluid is conveyed from the pressure cylinder to the operating cylinder, in order to drive the operating piston in a desired manner, and does not flow back into the reservoir. The first valve element may particularly be embodied as a non-return valve.

Additionally, the hydraulic pump valve apparatus may comprise a second valve element which is arranged between the operating cylinder and the pressure cylinder and is adapted to prevent a return flow of hydraulic fluid into the pressure cylinder from the operating cylinder. The second valve element may particularly be embodied as a non-return valve. In this way, it may be ensured that a defined return flow takes place when the hydraulic fluid flows back to the reservoir from the operating cylinder. Thus, the pressure cylinder is filled with hydraulic fluid from the reservoir, in particular. Typically, the hydraulic fluid from the reservoir is cooler than the hydraulic fluid from the operating cylinder, so that overheating of the pressing tool is prevented.

In particular, the first and/or second valve element may comprise a non-return ball valve or a non-return disc valve. A non-return ball valve comprises a fluidic passage which may be closed by means of a ball element. Typically, the ball element is pressed against a valve seat by means of a spring element and closes the fluidic passage in one direction. In non-return disc valves, a flat disc (disc element) instead of a ball element is used as a sealing object.

Preferably, no hydraulic line connections such as hydraulic hoses or screwed hydraulic joints are arranged between the pressure cylinder and the operating cylinder and/or between the operating cylinder and the reservoir. The fluidic passages which connect the pressure cylinder and the operating cylinder and/or the operating cylinder and the reservoir are preferably embodied integrally in a housing element. Due to the fact that hydraulic line connections are omitted, a compact construction and less complex hydraulic system may be realized.

In particular, the pressure cylinder, the operating cylinder and the pressure-relief valve of the pump valve apparatus may be embodied in a shared housing. For example, the fluid-carrying cavities may be milled out of one workpiece, or the housing is manufactured by means of additive methods such as 3D printing or metal sintering, for example. Equally, the housing may be cast housing. This makes a further reduction of the size possible.

The pressure-relief valve may comprise a latching means which is adapted to fix the pressure-relief valve element in an opened position when the pressure-relief valve reaches the opened position. Hence, the latching means serves to keep open the first fluidic passage after the pressure-relief valve has been opened. Accordingly, the latching means may be unlatched, i.e. release the pressure-relief valve element, in order to close the pressure-relief valve element and/or the first fluidic passage.

The operating piston may be coupled to the latching means in such a manner that the latching means releases the pressure-relief valve element, so that the pressure-relief valve element closes when the operating piston has reached a predefined position, particularly the first position. The coupling may be mechanical. For example, the returning operating piston unlatches the latching means by means of an actuating element. The predefined position may be adjustable, for example by means of an adjusting screw. Hence, closing the first fluidic passage may take place in a simple manner depending on the position of the operating piston. This ensures that the operating piston is in the predefined position before the first fluidic passage is closed and a new pressing cycle is started. Equally, the coupling may take place by means of a sensor which detects the position of the operating piston. A control of the pressing tool may emit a signal for closing the pressure-relief valve element in reaction to the detected position of the operating piston.

In particular, the operating cylinder may be coupled to the latching means in such a manner that the latching means releases the pressure-relief valve element, so that the pressure-relief valve element closes when the pressure in the operating cylinder falls below a predefined minimum pressing pressure and the operating piston has returned to the first position. In particular, monitoring the pressure in order to detect whether the pressure has fallen below a minimum pressing pressure may take place by means of a sensor. The coupling between the operating cylinder and the latching means may comprise an electrical component such as a control means. If a corresponding drop in pressure is detected, the control means may emit a signal for closing the pressure-relief valve element. In order to ensure that the operating piston has returned to the first position, emitting the signal for closing the pressure-relief valve element may be delayed.

The latching means may be a mechanical latching means, particularly a latching pin, and/or a magnetic latching means. Equally, the latching means may be an electronic, a pneumatic, or a hydraulic latching means. A mechanical latching means makes it possible to keep the first fluidic passage open without having to continue to supply energy while it is kept open. For example, the latching means latches into a complementary latching means in the opened position of the pressure-relief valve in order to keep the first fluidic passage open. Equally, the pressure-relief valve element may be built inversely. This means the initial position of the pressure-relief valve element is an opened position and the latching means latches in the closed position. A magnetic latching means may comprise a permanent and/or electromagnet, so that opening and/or keeping open the pressure-relief valve element may be controlled by correspondingly supplying electrical energy. An electronic latching means may comprise a servo-motor, for example.

Furthermore, the pressing tool may comprise an adjustment means which is adapted to adjust the predefined maximum pressing pressure and/or the predefined minimum pressing pressure. The adjustment means may comprise hardware and/or software as well as mechanical components. For example, corresponding pressure thresholds for the maximum pressing pressure and/or the minimum pressing pressure may be stored in the software of the control of the pressing tool. These pressure thresholds may be adjusted to the workpieces to be compressed in each case in order to prevent damage to the workpieces because of too high pressing forces. Equally, the adjustment means may mechanically vary an opening pressure of the pressure-relief valve element. For example, a retention clip of the pressure-relief valve element may be preloaded more or less intensely by means of the adjustment element in order to adjust the maximum pressing pressure. Other adjustment means are possible as well.

Furthermore, the pressing tool may comprise a control means and at least one sensor, wherein the sensor preferably is adapted to monitor the pressing pressure in the operating cylinder and wherein the control means controls at least the opening of the pressure-relief valve element. In this way it may be ensured that a maximum admissible pressing pressure is not exceeded.

The predefined maximum pressing pressure may be selected in such a manner that the pressing tool is adapted to apply a pressing force of at least 8 kN, preferably of at least 10 kN, more preferably of at least 19 kN, more preferably of at least 24 kN, and most preferably of at least 32 kN, to a workpiece by means of the pressing jaws. In this way, workpieces of different materials may be plastically deformed. In other fields of application, the predefined maximum pressing pressure may be selected in such a manner that the pressing tool is adapted to apply a pressing force of at least 60 kN, preferably of at least 108 kN, more preferably of at least 120 kN, more preferably of at least 130 kN, and most preferably of at least 150 kN, to a workpiece by means of the pressing jaws.

The drive of the pressing tool preferably comprises an electric motor and, optionally, a transmission and, particularly preferably, an eccentric element. Electric motors are particularly suitable for hand-held pressing tools because electric motors may be operated by means of a rechargeable battery. In this way, supply lines to the pressing tool are not necessary. The transmission may be a planetary gear and provide gear reduction, in particular. By means of the eccentric, a rotary motion may be converted into a linear motion, and thus, the pressure piston may be driven.

Furthermore, the problem is solved by means of a method of operating a pressing tool, particularly for plastically deforming a tubular workpiece. In this context, the pressing tool is a pressing tool as described above. The person skilled in the art recognizes that all advantages of the pressing tool described above may be achieved by means of the method. The method comprises at least the following method steps:
a) Providing a pressing tool;
b) Providing a pressing jaw assembly, comprising at least one pressing jaw (21a, 21b);
c) Coupling the pressing jaw assembly to the coupling interface of the pressing tool;
d) Gripping the workpiece by means of the at least one pressing jaw;
e) Driving the pressure piston by means of the drive in order to drive hydraulic fluid to the operating cylinder from the pressure cylinder by means of the pressure piston;
f) Applying pressing pressure to the operating piston in order to move the operating piston into a second position;
g) Transmitting pressing force from the operating piston to the pressing jaw assembly in order to plastically deform the gripped workpiece;
h) Opening the first fluidic passage by means of the pressure-relief valve element when a predefined maximum pressing pressure is reached; and
i) Keeping open the first fluidic passage until the operating piston has returned into the first position.

Subsequently, steps d) through i) may be repeated in order to carry out a new pressing cycle.

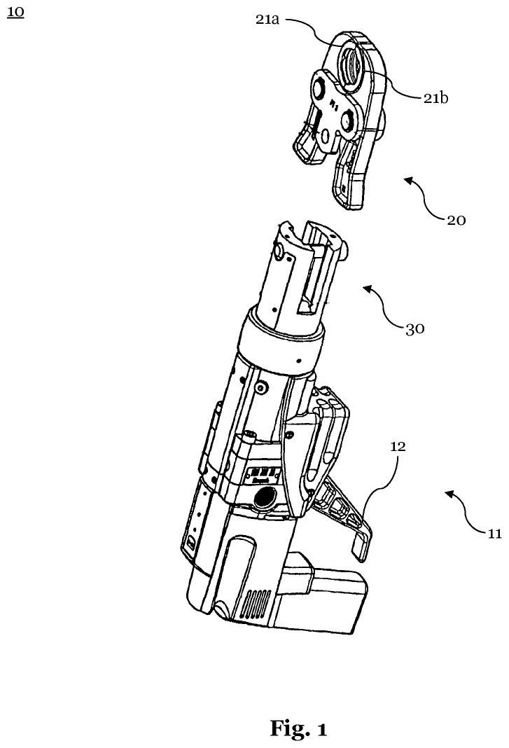

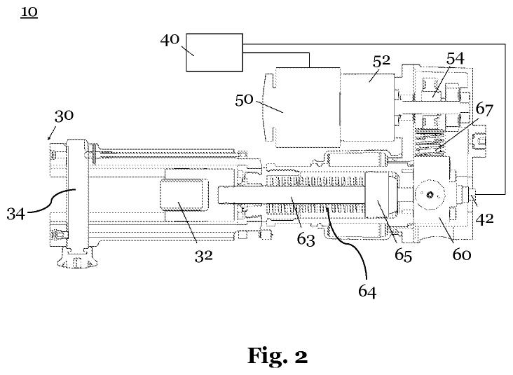

In FIG. 1, a pressing tool 10 according to an embodiment of the present invention is shown. In this context, the pressing tool 10 comprises a handle 11 which may be hand-held by an operator and/or user. A pressing jaw assembly 20 may be removably coupled to the handle 11. The pressing jaw assembly 20 comprises two pressing jaws 21a, 21b by means of which a fitting (not shown) may be gripped and plastically deformed. For this purpose, at least a motor and a hydraulic system (cf. FIG. 2), which drive the pressing jaw assembly 20 via a coupling interface 30 and, ultimately, may drive at least one of the pressing jaws 21a, 21b in order to deform the fitting, are provided in the handle 11. In order to deform the fitting, an operator may actuate a corresponding actuating lever 12. By accordingly actuating the actuating lever 12, the pressing jaws 21a, 21b are spread apart in order to grip a fitting, and subsequently pressed together in order to deform the fitting.

FIG. 2 shows a schematic sectional illustration of a pressing tool 10 according to an embodiment of the present invention. The pressing tool 10 comprises a drive which comprises an electric motor 50, a transmission 52 as well as an eccentric element 54. The motor 50 is controlled by a control means 40. The driving energy of the motor 50 is reduced by the transmission 52, for example a planetary gear, and transmitted to the eccentric element 54. The eccentric element 54, in turn, drives a pressure piston (not shown) which is mounted in a movable manner in a pressure cylinder 67.

The pressure piston displaces hydraulic fluid which is guided into an operating cylinder 65 by the pressure cylinder 67. In this process, a pressing pressure is applied to the hydraulic fluid, which pressure acts upon the operating piston (not shown) in the operating cylinder. The operating piston is coupled to a coupling interface 30. For this purpose, the pressing tool 10 may comprise a connecting element 63 which connects the operating piston to the coupling interface 30 in such a manner that force may be transmitted.

The coupling interface 30 serves to receive a pressing jaw assembly. For example, a pressing jaw assembly, as shown in FIG. 1, may be coupled to the pressing tool 10 by means of the coupling bolt 34. Furthermore, a coupling roller 32 makes the transmission of the pressing force and/or the relative motion of the operating piston to the at least one movable pressing jaw 21a, 21b of the pressing jaw assembly possible.

Furthermore, the pressing tool 10 comprises a pump valve apparatus 60. The pump valve apparatus comprises, inter alia, the pressure cylinder 67 as well as the operating cylinder 65. The pressure in the operating cylinder 65 is monitored by means of a sensor 42, for example. The control means 40 detects the sensor data of the sensor 42 and may open and keep open the pressure-relief valve element 82 of the pressing tool 10 when a maximum pressure is reached, so that hydraulic fluid may flow back into the reservoir 70 from the operating cylinder 65.

In order to drive the operating piston back into the first position from the second position, the pressing tool 10 preferably comprises a first spring element 64 which is configured as a compression spring in the present invention. The first spring element 64 drives the operating piston back into the first position from the second position in which the pressing jaws 21a, 21b are closed. In the first position, the pressing jaws 21a, 21b are at least partially opened. While the operating piston 66 returns into the first position from the second position, hydraulic fluid flows back into the reservoir (not shown here) from the operating cylinder 65.

Furthermore, the pressing tool 10 comprises a second spring element 69 which pushes the pressure piston into its initial position when the pressure piston is not driven by means of the drive and the pressure-relief valve element is open. In the initial position of the pressure piston, the pressure cylinder is at least partially filled with hydraulic fluid. Consequently, when the pressure piston is in the initial position, the pressing tool is ready for a (new) pressing cycle.

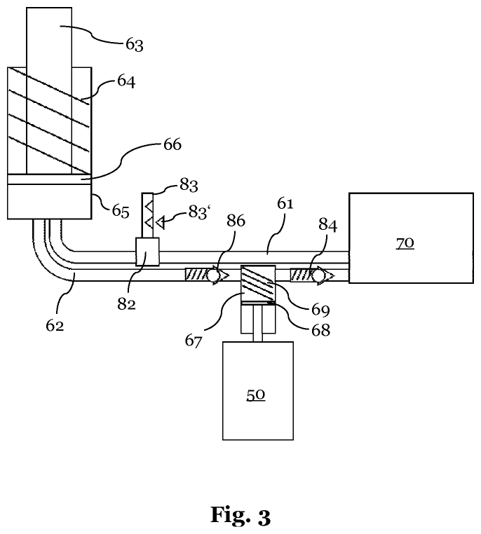

FIG. 3 shows a schematic illustration of the pump valve apparatus 60. The pump valve apparatus 60 is coupled to a reservoir 70 which provides hydraulic fluid. Furthermore, the pump valve apparatus 60 is coupled to the electric motor 50 by means of the pressure piston 68. The coupling may take place by other drive elements such as an eccentric element 54 and/or a transmission 52. In FIG. 3, the coupling is illustrated in a simplified manner. Potential transmissions or eccentric elements are not shown.

The pump valve apparatus 60 comprises first and second fluid conduits 61, 62, wherein the first fluid conduit 61 fluidically connects the reservoir 70 to the operating cylinder 65. The second fluid conduit 62 fluidically interconnects the operating cylinder and the pressure cylinder. Preferably, the fluid conduits are embodied integrally in a housing element, so that no hydraulic line connections are necessary between the individual components of the pump valve apparatus 60. In this manner, potential leakage spots are prevented and a simple, space-saving construction is achieved. In particular, by means of the integral construction, a high operating pressure may be reached in the pump valve apparatus 60, so that correspondingly compact pressing tools may provide a very high pressing force.

In the pressure cylinder 67, a pressure piston 68 is mounted in a movable manner, wherein the pressure piston 68 may be driven by means of the electric motor 50. In the initial position, the pressure cylinder 68 is filled with hydraulic fluid. When the pressure piston 68 is driven, it pushes hydraulic fluid from the pressure cylinder 67 in the direction of the operating cylinder 65. To be able to push the pressure cylinder 68 back into its initial position, a compression spring 69 is provided in the pressure cylinder 67.

The operating cylinder 65 comprises an operating piston 66 that is mounted in a sliding manner. In a first position, the operating piston 66 is at least partially retracted. When pressing pressure is applied to the operating cylinder 65, the operating piston 66 may be moved out of the first position and driven into a second position. The application of pressing pressure takes place by means of the pressure piston 68 as described above. While the operating piston 66 is moved from the first into the second position, a pressing jaw assembly coupled to the pressing tool 10 is closed in order to plastically deform a workpiece.

In order to move the operating piston 66 back into the first position from the second position, the first fluid conduit 61 between the operating cylinder 65 and the reservoir 70 is opened. For this purpose, the pressure-relief valve element 82 is opened. A first spring element 64 may then push the operating piston 66 back into the first position.

In particular, when a preset maximum pressing pressure is reached in the operating cylinder 65, the pressure-relief valve element 82 is opened and subsequently kept open, so that hydraulic fluid may flow back into the reservoir 70 from the operating cylinder 65.

Keeping open the pressure-relief valve element 82 takes place by means of the latching means 83 which may latch into a complementary latching means 83′. In FIG. 3, a mechanical latching means 83 is shown. Equally, the latching means 83 may also be a magnetic latching means. For example, the latching means may comprise a permanent magnet which latches into a complementary latching means 83′ which comprises an electromagnet. Other latching means and/or complementary latching means 83′ are also possible for keeping open the pressure-relief valve element 82.

To ensure that hydraulic fluid exclusively flows from reservoir 70 in the direction of the pressure cylinder 67 to the operating cylinder 65 in the second fluid conduit 62, the first and second valve elements 84, 86 may be provided between the pressure cylinder 67 and the reservoir 70 as well as between the operating cylinder 65 and the pressure cylinder 67, which prevents a return flow of the hydraulic fluid in the direction of the reservoir 70. Hence, a defined direction of flow of the hydraulic fluid of the pump valve apparatus 60 is predetermined. The fluid flows into the pressure cylinder 67 from the reservoir 70 during a pressing cycle. From there, it is pushed into the operating cylinder 65 and may return to the reservoir 70, after the pressure-relief valve element 82 has been opened, in order to be provided to the operating cylinder 67 again.

In particular, the first and/or second valve element 84, 86 may be designed as a non-return valve. By keeping the first fluid conduit 61 open by means of pressure-relief valve element 82, the operating piston 66 may be returned into the first position. After the first position has been reached, the pressure-relief valve element 82 may be closed again. After the pressure-relief valve element 82 has been closed, the pressing tool is ready for another pressing cycle.

### LIST OF REFERENCE NUMBERS

10 Pressing tool
11 Handle
12 Actuating lever
20 Pressing jaw assembly
21a, 21b Pressing jaw
30 Coupling interface
32 Coupling roller
34 Coupling bolt
40 Control means
42 Sensor
50 Electric motor
52 Transmission
54 Eccentric element
60 Pump valve apparatus
61 First fluid conduit
62 Second fluid conduit
63 Connecting element
64 First spring element
65 Operating cylinder
66 Operating piston
67 Pressure cylinder
68 Pressure piston
69 Second spring element
70 Reservoir
82 Pressure-relief valve element
83 Latching means
83′ Complementary latching means
84 First valve element
86 Second valve element

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A pressing tool for plastically deforming a tubular workpiece, comprising:
a drive;
a reservoir for providing a hydraulic fluid;
a coupling interface for coupling the pressing tool to a pressing jaw assembly, and
a hydraulic pump valve apparatus, wherein the hydraulic pump valve apparatus comprises:
a pressure cylinder in which a pressure piston is mounted in a movable manner, wherein the pressure piston may be driven by means of the drive;
an operating cylinder in which an operating piston is mounted in a movable manner in order to be moved from a first position into a second position, wherein the operating cylinder is fluidically connected to the pressure cylinder, so that hydraulic fluid may be driven to the operating cylinder from the pressure cylinder by means of the pressure piston in order to apply a pressing pressure to the operating piston and move it into the second position, wherein
the operating piston is coupled to the coupling interface and wherein the coupling interface is adapted to transmit a pressing force from the operating piston to a pressing jaw assembly when the pressing jaw assembly is coupled to the coupling interface;
a pressure-relief valve element which is adapted to open a first fluidic passage from the operating cylinder to the reservoir when a predefined maximum pressing pressure is reached, and wherein the pressure-relief valve element is further adapted to keep open the first fluidic passage until the operating piston has returned into the first position.

2. The pressing tool according to claim 1, wherein the hydraulic pump valve apparatus further comprises a first valve element which is arranged between the reservoir and the pressure cylinder and is adapted to prevent a return flow of hydraulic fluid into the reservoir from the pressure cylinder.

3. The pressing tool according to claim 1, wherein the hydraulic pump valve apparatus further comprises a second valve element which is arranged between the operating cylinder and the pressure cylinder and is adapted to prevent a return flow of hydraulic fluid into the pressure cylinder from the operating cylinder.

4. The pressing tool according to claim 2, wherein the first valve element comprises a non-return ball valve or a non-return disc valve.

5. The pressing tool according to claim 3, wherein the second valve element comprises a non-return ball valve or a non-return disc valve.

6. The pressing tool according to claim 1, wherein no hydraulic line connections are arranged between the pressure cylinder and the operating cylinder.

7. The pressing tool according to claim 1, wherein no hydraulic line connections are arranged between the operating cylinder and the reservoir.

8. The pressing tool according to claim 1, wherein the pressure cylinders and the operating cylinder and the pressure-relief valve element of the pump valve apparatus are provided in one shared housing.

9. The pressing tool according to claim 1, wherein the pressure-relief valve element comprises a latching means which is adapted to fix the pressure-relief valve element in an opened position when the pressure-relief valve element reaches the opened position.

10. The pressing tool according to claim 9, wherein the operating piston is coupled to the latching means in such a manner that the latching means releases the pressure-relief valve element, so that the pressure-relief valve element closes when the operating piston has reached a predefined position.

11. The pressing tool according to claim 10 wherein the predefined position of the operating piston is the first position.

12. The pressing tool according to claim 9, wherein the operating cylinder is coupled to the latching means in such a manner that latching means releases the pressure-relief valve element, so that the pressure-relief valve element closes when the pressure in the operating cylinder falls below a predefined minimum pressing pressure and the operating piston has returned to the first position.

13. The pressing tool according to claim 9, wherein the latching means is a mechanical latching means.

14. The pressing tool according to claim 9, wherein the latching means is a magnetic latching means.

15. The pressing tool according to claim 1, wherein the pressing tool further comprises an adjustment means which is adapted to adjust at least one of the predefined maximum pressing pressure and the predefined minimum pressing pressure.

16. The pressing tool according to claim 1, wherein the pressing tool further comprises a control means and at least one sensor, wherein the sensor is adapted to monitor the pressing pressure in the operating cylinder and wherein the control means controls at least the opening of the pressure-relief valve element.

17. The pressing tool according to claim 1, wherein the predefined maximum pressing pressure is selected in such a manner that pressing tool is adapted to apply a pressing force of at least 8 kN to a workpiece by means of the pressing jaws.

18. The pressing tool according to claim 1, wherein the drive comprises an electric motor.

19. The pressing tool according to claim 18, wherein the drive further comprises at least one of a transmission and an eccentric element.

20. A method of operating a pressing tool, the method comprising:
providing a pressing tool including a drive, a reservoir for providing a hydraulic fluid, a coupling interface for coupling the pressing tool to a pressing jaw assembly, and a hydraulic pump valve apparatus, wherein the hydraulic pump valve apparatus includes (i) a pressure cylinder in which a pressure piston is mounted in a movable manner, wherein the pressure piston may be driven by means of the drive, (ii) an operating cylinder in which an operating piston is mounted in a movable manner in order to be moved from a first position into a second position, and (iii) a pressure-relief valve element which is adapted to open a first fluidic passage from the operating cylinder to the reservoir when a predefined maximum pressing pressure is reached;
providing a pressing jaw assembly, comprising at least one pressing jaw;
coupling the pressing jaw assembly to the coupling interface of the pressing tool;
gripping the workpiece by means of the at least one pressing jaw;
driving the pressure piston by means of the drive in order to drive hydraulic fluid to the operating cylinder from the pressure cylinder by means of the pressure piston;
applying pressing pressure to the operating piston in order to move the operating piston into a second position;
transmitting pressing force from the operating piston to the pressing jaw assembly in order to plastically deform the gripped workpiece;
opening the first fluidic passage by means of the pressure-relief valve element when a predefined maximum pressing pressure is reached; and
keeping open the first fluidic passage until the operating piston has returned into the first position.
